(19) United States
(12) Patent Application Publication
(10) Pub. No.: US 2002/0180359 A1
(43) Pub. Date: Dec. 5, 2002

(54) Discharge lamp with indium and erbium fill

(76) Inventors: Douglas A. Kirkpatrick, Great Falls, VA (US); Robert H. Riedell, Clarksville, MD (US); Brian P. Turner, Germantown, MD (US)

Correspondence Address: FUSION LIGHTING INC, PAUL E STEINER, 7524 STANDISH PLACE, ROCKVILLE, MD, 20855

(21) Appl. No.: 10/020,226

(22) Filed: Dec. 18, 2001

Related U.S. Application Data
(60) Provisional application No. 60/256,350, filed on Dec. 19, 2000.
(60) Provisional application No. 60/256,353, filed on Dec. 19, 2000.

(51) Int. Cl. H01J 17/20

(52) U.S. Cl. 313/639

(57) ABSTRACT

A discharge lamp includes a light transmissive envelope, a fill disposed within the light transmissive envelope, the fill producing a light discharge when excited, and an excitation structure for exciting the fill to produce the light discharge, wherein the fill includes a primary fill constituent of indium halide and a fill additive of a small amount of erbium. A two panel projection system utilizes the indium and erbium discharge lamp, with one panel dedicated to blue light and the other panel sequenced between red and green light.

### BACKGROUND

1. Field of the Invention

The invention relates generally to electrodeless lamps and more specifically to an electrodeless discharge lamp with a novel fill.

2. Related Art

In general, the present invention relates to the type of lamps described in U.S. Pat. No. 6,137,237 and PCT Publication No. WO 01/03161, each of which is herein incorporated by reference in its entirety.

Indium is well known as a material for a fill constituent in a discharge lamp. U.S. Pat. No. 3,234,421 issued to Reiling is one of the first patents on metal halides lamps. Reiling identifies indium as one of many metallic halides useful for producing a white or near white discharge. U.S. Pat. No. 3,259,777, issued to Fridrich describes an electroded discharge lamp which utilizes indium halides as a primary fill constituent. The resulting spectrum is a broad, continuous spectrum from molecular radiation with an emphasis in the blue region, trailing off through the green and red regions. Commercial versions of an indium halide arc lamp were sold by Sylvania under the Colorarc trade name.

An electrodeless version of an indium halide discharge lamp is described in European Paten Publication No. EP 0 407 160 A2. The disclosed lamp structure provides a standing wave discharge. An article by Hochi, et al., entitled “Novel high color rendering electrodeless HID lamp containing InX,” discloses an electrodeless microwave discharge lamp utilizing an indium halide fill (published in IDW '96, Proceedings of the Third International Display Workshops, Volume 2, pp. 435-438).

U.S. Pat. No. 6,137,237, owned in common with the present application, describes an inductively coupled electrodeless discharge lamp having an indium halide fill producing visible light in a broad continuous spectrum.

Erbium is also known as a fill constituent in a discharge lamp. U.S.

Pat. No. 4,020,377 discloses a metal halide discharge lamp having a rare earth metal as the primary fill constituent and a alkaline earth metal as a fill additive used to increase the vapor pressure of the rare earth metal. The examples given describe dysprosium as the primary light emitting fill constituent together with sodium and thallium as fill additives to increase vapor pressure and tin as a fill additive to absorb blue radiation and reduce color temperature. An alternative disclosed rare earth material includes erbium and an alternative disclosed alkaline earth metal includes indium.

U.S. Pat. No. 5,568,008 also discloses an arc lamp in which a rare earth metal is the primary fill constituent and which may further include an alkali metal as a fill additive. The examples indicate dysprosium, neodymium, and cesium halides as fill materials. Alternative disclosed rare earth materials include erbium. This patent further discloses that a fill additive of indium improves blue emission characteristics.

U.S. Pat. No. 5,013,968 describes a metal halide lamp with line emission in the blue, green, and red bands from zinc, indium, lithium, and thallium. Indium is not the primary fill constituent and is indicated as being preferably 25 mole % or less of the combined total moles of indium, lithium, and thallium present. The patent indicates that the addition of a rare earth metal to the fill improves lumen maintenance and increases lamp life. The preferred rare earth metals are lanthanum, scandium, and dysprosium. Erbium is included in a list of alternative rare earth metals.

Other patents which describe erbium as a fill constituent include U.S. Pat. Nos. 4,176,299; 5,451,838; 5,773,932; 5,973,454; and 6,005,356.

### SUMMARY

The following and other objects, aspects, advantages, and / or features of the invention described herein are achieved individually and in combination. The invention should not be construed as requiring two or more of such features unless expressly recited in a particular claim.

A novel discharge lamp includes indium as a primary fill constituent together with a small amount of erbium. The addition of a small amount of erbium produces a surprisingly large increase in the light output, especially in the green and red regions of the spectrum.

Another object of the invention is to provide a two panel projection system with good color gamut and good color balance.

### BRIEF DESCRIPTION OF THE DRAWINGS

The foregoing and other objects, features, and advantages of the invention will be apparent from the following more particular description of preferred embodiments as illustrated in the accompanying drawings, in which reference characters generally refer to the same parts throughout the various views. The drawings are not necessarily to scale, the emphasis instead being placed upon illustrating the principles of the invention.

FIG. 1 is a schematic diagram of an electrodeless discharge lamp.

FIG. 2 is a schematic, cross sectional view of an aperture bulb.

FIG. 3 is a graph of the spectrum of an indium-erbium discharge lamp in accordance with the present invention.

FIG. 4 is a comparison graph of the indium-erbium spectrum of the present invention versus a comparable indium only spectrum.

FIG. 5 is a schematic diagram of a two panel projection system.

### Description

In the following description, for purposes of explanation and not limitation, specific details are set forth such as particular structures, interfaces, techniques, etc. in order to provide a thorough understanding of the various aspects of the invention. However, it will be apparent to those skilled in the art having the benefit of the present disclosure that the various aspects of the invention may be practiced in other examples that depart from these specific details. In certain instances, descriptions of well known devices, circuits, and methods are omitted so as not to obscure the description of the present invention with unnecessary detail.

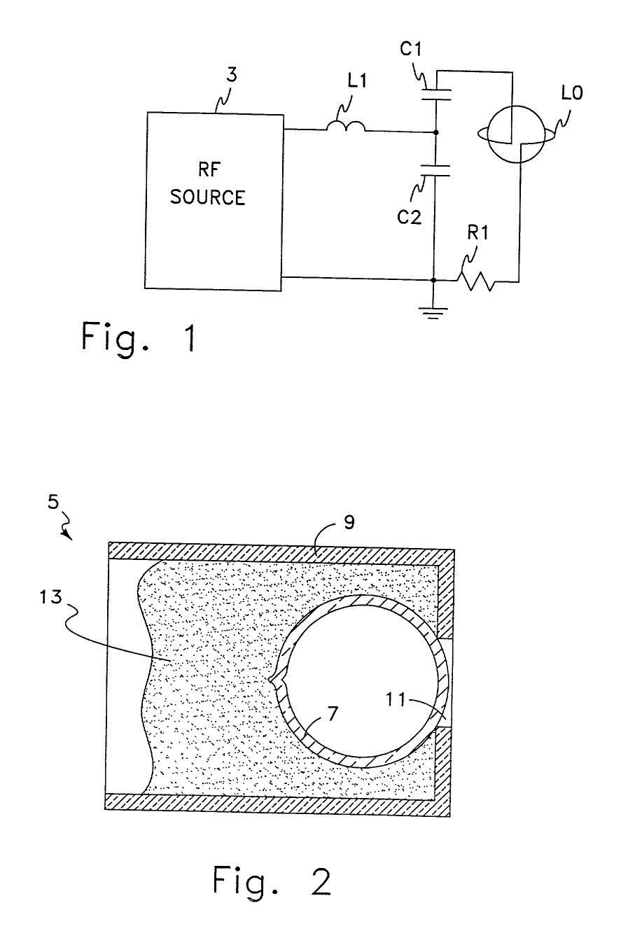

With reference to FIG. 1, an example lamp structure which is useful for exciting a discharge in the lamp fill described herein is described more fully in the above referenced '237 patent and '302 applications. Briefly, a series resonant circuit includes two capacitors C1 and C2 connected in series with each other and connected in series with a series resonant coil LO. A power source 3 provides a high frequency signal through a small inductance L1 to the junction of C1 and C2. The other side of C1 is grounded. The series resonant coil L0 is also connected to ground through a small resistance R1, which represents the lumped circuit resistance.

With reference to FIG. 2, a preferred bulb structure includes an aperture lamp 5 having an electrodeless bulb 7 disposed in a ceramic cup 9. The ceramic cup 9 is open on open end and closed on the other end except for a light emitting aperture 11. The bulb 7 is disposed inside the cup 9 and against the aperture 11. The bulb 7 is encased in reflective ceramic material 13. The indium and erbium fill of the present invention is enclosed within the volume of the bulb 7.

Without limitation, alternative discharge lamp structures which may beneficially utilize the novel fill disclosed herein include capacitively coupled lamps, microwave discharge lamps, standing wave discharge lamps, and electroded arc lamps.

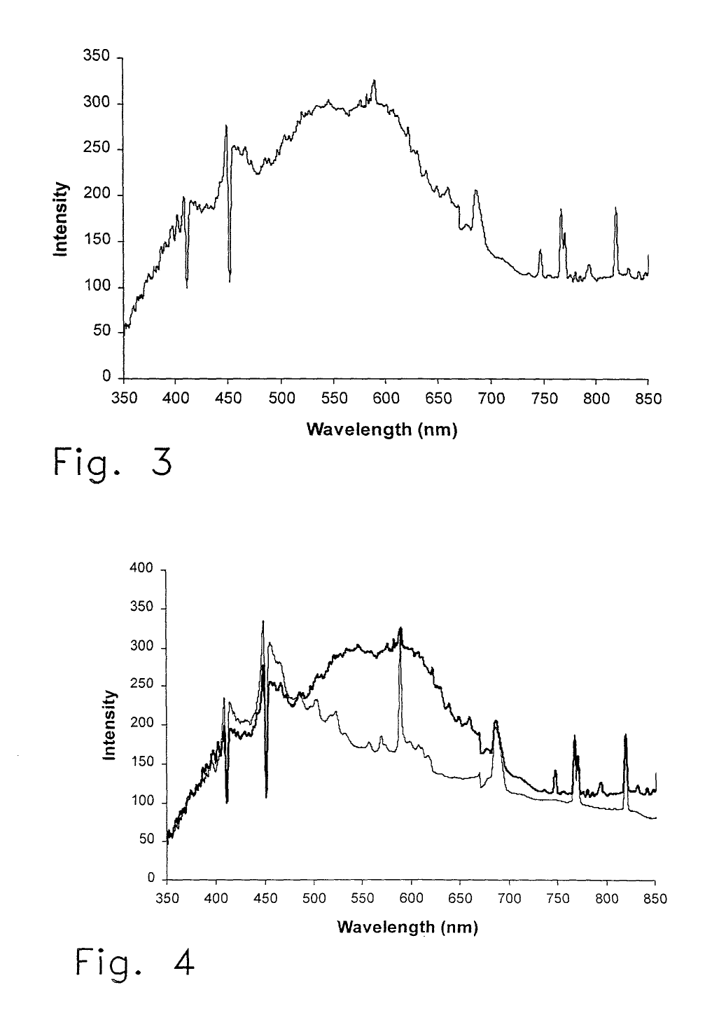

An example lamp is configured as follows. A roughly spherical electrodeless bulb having a 7 mm outer diameter and a 6 mm inner diameter encloses a fill of 0.135 mg indium chloride (i.e. about 1.2 mg/cc InCl) and a small amount of erbium tri-chloride on the order of less than 0.05 mg ErCl₃ (e.g. about 0.02 mg ErCl₃ or between about 0.1 mg/cc and 0.5 mg/cc erbium halide). The fill further includes 25 Torr krypton and a small amount of Kr₈₅ for starting. The bulb is configured as an aperture lamp with a 3.4 mm diameter round aperture. The fill concentrations for a non-aperture lamp would be higher. The aperture capsule is placed in an inductively coupled lamp with a wedding ring style excitation coil with the bulb approximately centered with respect to the coil. Approximately 130 to 200 watts (W) of RF energy at about 700 MHz are applied to the lamp head. The resulting spectrum is shown in FIG. 3. The color rendering index (CRI) for the lamp is in excess of 90 with the correlated color temperature (CCT) in the region of 5000° K (e.g. CRI=91, CCT=49000° K). At 200 W RF, total lumen output is 5948 lumens.

With reference to FIG. 4, the above resulting spectrum is graphed against a comparable spectrum of the same fill without the addition of the small amount of erbium. The spectra were taken at similar RF power levels with similar test apparatus. As can be seen from FIG. 4, the addition of a small amount of erbium produces a significant amount of increased light output, especially in the green and red regions of the spectrum. For the same power input, the lumen output is increased at least 10% and generally between about 20 to 30 percent for the indium/erbium fill as compared to the indium only fill. The higher efficacy of the indium/erbium fill facilitates higher power loading with corresponding higher brightness output.

While the inventors do not wish to be limited by theory, it is believed that the indium halide brings the erbium tri-halide into the discharge at reasonably low wall temperatures. The spectral effect is an unexpected result based on prior understandings of erbium halide discharges.

The spectrum produced by the novel fill of the present invention is useful for many applications including projection displays, general illumination, vehicle headlamps, fiber optic illumination, and other applications which require or benefit from artificial light.

### Two Panel Production System

The present aspect of the invention relates generally to projection systems and more specifically to color sequential projection systems.

In a three color display system, a projection engine may use one, two or three imaging devices (also referred to herein as “panels”). With a three panel system, the light is split into three colors by suitable optics and filters and each color is directed to a separate imager. Total light output is high, but it is difficult to maintain alignment of the three panels and cost is high because three relatively costly imaging devices are required.

Color sequential projection systems are well known in the art. In a one panel system, light from a light source is time multiplexed into three or more sequential colors (e.g. red, green, and blue) by a rotating color wheel or color shutters. The color sequential light is directed to a single imaging device which modulates the light with individual pixel elements which are synchronized with the color scheme. For example, pixels corresponding to the red portion of an image are actuated when the red portion of the color sequential light is on the imager. The one panel system is less expensive and requires no alignment, but the light output is lower because only a fraction (e.g. one third) of the available light is imaged onto the screen.

A two panel system is a compromise between the cost and alignment problems of the three panel system and the lower light of the one panel system. For example, U.S. Pat. No. 5,822,021 describes a two panel projection system which splits light along two optical paths with one color or set of colors going along each path. For example, the first path may correspond to blue light only and the second path may include red and green light. A color shutter is used to time sequence the light in the second path between red and green. The first optical path (e.g. the blue light) includes a first liquid crystal imaging device forming a first image which corresponds at all times to the blue portion of the image. The second optical path includes a second liquid crystal imaging device forming a second image which switches between the red and green portions of the image. The first and second images are combined to provide a full color image.

As compared to the three panel system, the two panel system is easier to align, but has lower light output. As compared to the single panel system, the two panel requires some alignment but has higher light output because a greater fraction of the light is utilized.

An object of the present invention is to provide a two panel projection system with good color gamut and good color balance.

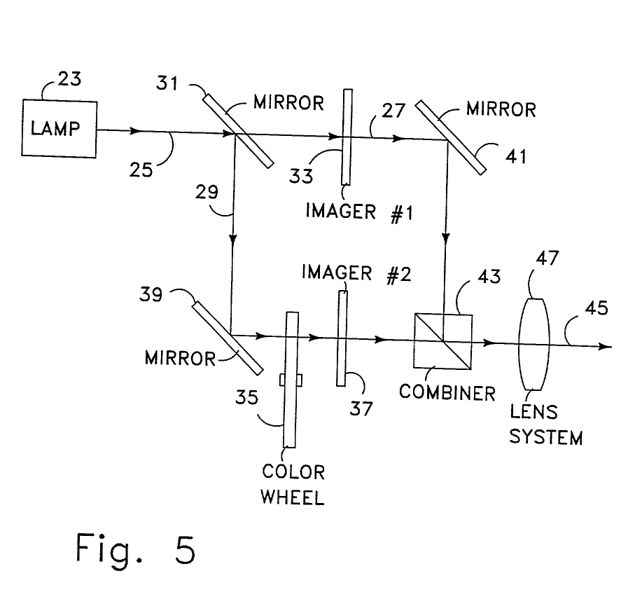

With reference to FIG. 5, a projection system includes a lamp 23 which preferably provides full spectrum light. The light 25 from the lamp 23 is split into a first optical path 27 and a second optical path 29 by, for example, a dichroic mirror 31.

The mirror 31 is configured to transmit blue light and to reflect green and red light. The first optical path 27 includes a first imager 33 which is adapted to modulate the light in accordance with the blue portion of an image. The second optical path 29 includes a color wheel 35 and a second imager 37. For example, one half of the color wheel 35 comprises a red light filter and the other half of the color wheel 35 comprises a green light filter so that the light on the imager 39 is time sequenced between red and green. Of course, other splits of green and red (e.g. 60/40) may be used as desired. The imager 39 is adapted to modulate the light thereon in accordance with the red and green portions of the image and in synchronization with the rotation of the color wheel 35.

Mirrors 39, 41 and I or other suitable optics are utilized to direct light along the respective optical paths 27, 29 and to direct the modulated light to a combiner 43. The merged image 45 is directed through a suitable lens system 47 onto, for example, a display screen.

The imagers 33, 37 may be reflective or transmissive devices including, for example, liquid crystal devices or digital micro-mirrors devices. Polarizing elements may also be included the optical paths 27, 29 as necessary. Prisms and/or other beam splitting optics may also be utilized as necessary or desirable.

In general, preferred light sources for the projection systems described herein are lamps of the type described in U.S. Pat. No. 6,137,237 and PCT Publication No. WO 01/03161, each of which is herein incorporated by reference in its entirety.

The novel discharge lamp described above includes indium as a primary fill constituent together with a small amount of erbium. The addition of a small amount of erbium produces a surprisingly large increase in the light output, especially in the green and red regions of the spectrum. This related application is incorporated by reference herein in its entirety.

With reference to FIG. 3, the indium-erbium discharge has high light output in the green and red regions, but less light output in the blue region. In accordance with the present invention, an indium-erbium discharge lamp is utilized in a two-panel projection system with the blue light on all the time on the first imager and with the red and green light split time-wise on the second imager. The amount of blue light in the transmitted spectrum is effectively doubled. It is believed that with an indium-erbium discharge lamp in a two panel system, a color specification may be achieved which meets or exceeds the SMPTE NTSC HDTV requirements.

While the invention has been described in connection with what is presently considered to be the preferred examples, it is to be understood that the invention is not limited to the disclosed examples, but on the contrary, is intended to cover various modifications and equivalent arrangements included within the spirit and scope of the inventions.

What is claimed is:

1. A discharge lamp, comprising:
a light transmissive envelope;
a fill disposed within the light transmissive envelope, the fill producing a light discharge when excited; and
an excitation structure for exciting the fill to produce the light discharge,
wherein the fill includes a primary fill constituent of indium halide and a fill additive of a small amount of erbium.

2. The lamp as recited in claim 1, wherein the erbium is present in amount which increases the lumen output at least ten percent as compared to a similarly configured lamp with no erbium fill additive.

3. The lamp as recited in claim 1, wherein the erbium is present in amount which increases the lumen output greater than about twenty percent as compared to a similarly configured lamp with no erbium fill additive.

4. The lamp as recited in claim 1, wherein the erbium is present as an erbium halide in a fill concentration of between 0.1 mg/cc and 0.5 mg/cc.

5. A discharge lamp, comprising:
a light transmissive envelope;
a fill disposed within the light transmissive envelope, the fill producing a light discharge when excited; and
an excitation structure for exciting the fill to produce the light discharge,
wherein the fill consists essentially of a primary fill constituent of indium halide, an inert gas, and erbium halide in a concentration of between 0.1 mg/cc and 0.5 mg/cc.

6. A projection system, comprising:
a light source including a fill for producing a light discharge, wherein the fill includes a primary fill constituent of indium halide and a fill additive of a small amount of erbium;
first optics for splitting light from the light source into a first component and a second component, wherein the first component comprises primarily blue light and wherein the second component comprises primarily green and red light,
a first light modulator adapted to receive the first component of light;
a second light modulator adapted to receive the second component of light; and
second optics positioned in between the first optics and the second light modulator and adapted to sequence the light provided to the second light modulator between green and red.
